(19) United States
(12) Patent Application Publication
(10) Pub. No.: US 2012/0176786 A1
(43) Pub. Date: Jul. 12, 2012

(54) Shaped Reflectors for Enhanced Optical Diffusion in Backlight Assemblies

(75) Inventors: Harry Presley, Alpharetta, GA (US); Bill Dunn, Alpharetta, GA (US); David Williams, Alpharetta, GA (US)

(73) Assignee: AMERICAN PANEL CORPORATION, Alpharetta, GA (US)

(21) Appl. No.: 13/182,571

(22) Filed: Jul. 14, 2011

Related U.S. Application Data
(60) Provisional application No. 61/364,653, filed on Jul. 15, 2010.

(51) Int. Cl. F21V 7/04

(52) U.S. Cl. 362/225; 362/241

(57) ABSTRACT

An assembly for diffusing a plurality of light sources. A diffusing device is placed adjacent to the plurality of light sources and preferably contains a plurality of shaped reflectors placed on the diffusing device where a shaped reflector is positioned adjacent to each light source. The shaped reflectors are placed in a one-to-one relationship with the light sources, which can be LED or fluorescent or any other type of light source. The reflectors may be single-tone, multi-tone, or gradient-tone and generally have a higher amount of reflectivity near the central axis of the light source and a lower reflectivity away from the central axis of the light source. The shaped reflectors may be used in both direct-lit and edge-lit orientations.

### CROSS-REFERENCE TO RELATED APPLICATIONS

This application claims priority to U.S. application Ser. No. 61/364,653 filed on Jul. 15, 2010, herein incorporated by reference in its entirety.

### TECHNICAL FIELD

Exemplary embodiments generally relate to an optical diffuser for backlights.

### BACKGROUND OF THE ART

Many liquid crystal displays (LCDs) employ a backlight assembly to generate light that passes through a stack of components consisting of a variety of glass and plastic layers, ultimately including the liquid crystal (LC) layer and its controller that is typically but not always a thin-film transistor. A typical LCD contains millions of pixels each consisting of primary color sub-pixels (commonly red, green, and blue) that are individually controlled to determine the instantaneous color for each pixel of the display. The particular makeup of the overall LCD stack of components determines the visual properties of the displayed image including brightness, color range, image resolution, and viewing angles.

A recently popular approach used for backlighting an LCD is a 2-D array of light-emitting diodes (LEDs) mounted on a planar printed circuit board (PCB), otherwise known as a ‘direct lit’ orientation. Each LED is essentially a discrete point-source of light that emits light most strongly on-axis, yet the desired appearance of the LCD should be substantially uniform; therefore the light from the LEDs should preferably be diffused (i.e. homogenized) so as to appear uniform by the viewer through the LC layer. Typically, the common means for diffusing the LED light is to provide sufficient space above the LEDs so that the light from each LED sufficiently overlaps the neighboring LEDs, and then placing a sheet of light-scattering material at this point. The distance between the LEDs and the light-scattering material is typically referred to as the ‘throw distance.’ The light-scattering material may be placed at a minimum throw distance so that it can effectively homogenize the light prior to entering the LC layer. A throw distance longer than the required minimum simply makes it easier to homogenize the light, but increases the overall thickness of the LCD, so there is an inherent tradeoff.

The light-scattering material is typically called a ‘diffuser’ and is often a milky-white plastic sheet that homogenizes light via scattering from internally embedded micro-particles typically consisting of white pigments. Unfortunately micro-particle scattering generally absorbs some of the light which in turn reduces the optical transmission of the diffuser, so there are practical limitations as to how much homogenization can be provided by this approach alone. More particularly, although a high volumetric density of micro-particles improves the ability of a diffuser to homogenize LED light the downside is a net reduction in transmitted light which is undesirable from the perspective of energy efficiency and overall brightness.

It is now desirable in the industry to decrease the overall thickness of common display assemblies and subsequently it is therefore desirable to reduce the throw distance between the LEDs and the diffuser. It is also desirable to reduce the electrical power consumption of backlight devices by improving the optical efficiency of the backlight assembly. Using previous technologies alone however, would result in either insufficient homogenization and/or reduced transmission of the light prior to entering the LC layer (or backlighting a static graphic).

### SUMMARY OF EXEMPLARY EMBODIMENTS

Exemplary embodiments provide a diffusing element such as a sheet of plastic or glass that serves to suspend a plurality of shaped reflectors directly above each LED in a planar 2-D array. In doing so the strongest on-axis light from each LED is predominately reflected back toward the LED where, via multiple reflections, the light homogenization is enhanced. In general, it may be preferable that the reflectors are not 100% reflective but instead are partially reflective in order to allow a certain amount of the on-axis light to pass directly through, with the particular amount being optimized for the application. This serves to avoid an ‘eclipse’ or ‘shadow’ effect that may otherwise result from a reflectivity of 100% that could be counter-productive to the goal of uniformly homogenizing the light. A large degree of flexibility exists in selecting the materials, shapes, and fabrication techniques of the reflectors, and this allows for optimized trades considering performance and cost. In some embodiments the shaped reflectors may provide the sole means for light homogenization. In other embodiments the shaped reflectors may be used in conjunction with other diffusion technologies such as micro-particle scattering as a means of overall diffuser enhancement. The various shaped reflector embodiments allow an increased ability to diffuse the LED light within a shorter throw distance, thereby producing a thinner overall backlight assembly.

While direct-lit LED backlights for LCDs are one environment for using the exemplary embodiments, there are other applications for which a better diffusing device would be useful. It will be understood by those skilled in the art that these embodiments are also applicable to other types of LCD backlights, including but not limited to edge-lit LED backlights and both direct and edge-lit fluorescent backlights, as well as hybrid LCD backlights consisting of both direct and edge-lit technologies. Further, backlights are also used for static advertising displays (ex. a backlit photograph or printed image) and these can use any type of illumination source (LED, fluorescent, electroluminescent, etc.) and may be direct-lit, edge-lit, or any combination thereof. Finally, as LEDs and other types of point-sources of light begin to be useful for common indoor/outdoor spatial lighting applications, the ability to effectively homogenize the light with a short throw distance may again prove useful. The exemplary embodiments herein can be used with any of these assemblies as well.

Other shaped reflector embodiments can reduce the common problem of ‘headlighting’ and ‘edge glow’ in edge-lit backlight assemblies. The actual properties of the shaped reflectors (including the size, shape, and reflectivity) may be optimized for particular applications with the aid of non-sequential optical ray-tracing software such as ASAP® from Breault Research Organization (Tucson, Ariz.—www.breault.com) and LightTools® from Optical Research Associates (Pasadena, Calif.—www.opticalres.com).

The foregoing and other features and advantages of the exemplary embodiments will be apparent from the following more detailed description of the particular embodiments of the invention, as illustrated in the accompanying drawings.

### BRIEF DESCRIPTION OF THE DRAWINGS

A better understanding of exemplary embodiments of the invention will be obtained from a reading of the following detailed description and the accompanying drawings wherein identical reference characters refer to identical parts and in which:

FIG. 1 is a side view of a typical micro-particle scattering diffuser device used with a plurality of LEDs in a direct-lit assembly;

FIG. 2 is a side view of an exemplary embodiment of the shaped reflector diffuser device incorporating shaped reflectors used with a plurality of LEDs in a direct-lit assembly;

FIG. 3 is a bottom view of one embodiment for distributing the shaped reflectors across the diffusing device used with a plurality of LEDs in a direct-lit assembly;

FIGS. 4A-4F are bottom views of other embodiments for the shaped reflectors based on a single-tone fabrication process used with a plurality of LEDs in a direct-lit assembly;

FIGS. 5A-5D are bottom views of other embodiments for the shaped reflectors and reflection densities based on multi-tone fabrication processes used with a plurality of LEDs in a direct-lit assembly;

FIGS. 6A-6F are bottom views of other embodiments for the shaped reflectors and reflection densities based on gradient-tone fabrication processes used with a plurality of LEDs in a direct-lit assembly;

FIG. 7A is a top view of a typical fluorescent tube direct-lit backlight assembly;

FIG. 7B is a top view of an embodiment for use with a fluorescent tube direct-lit backlight assembly as shown in FIG. 7A using shaped reflectors and reflection densities based on gradient-tone fabrication processes;

FIG. 8A is a partial top view of a portion of a typical LED edge-lit backlight assembly;

FIG. 8B is a partial top view of an embodiment for use with LED edge-lit backlight assemblies as shown in FIG. 8A using shaped reflectors and reflection densities based on gradient-tone fabrication processes;

FIG. 9A is a partial top view of a portion of a typical fluorescent tube edge-lit backlight assembly; and

FIG. 9B is a partial top view for an embodiment for use with a fluorescent tube design as shown in FIG. 9A using shaped reflectors and reflection densities based on gradient-tone fabrication processes.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/ or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

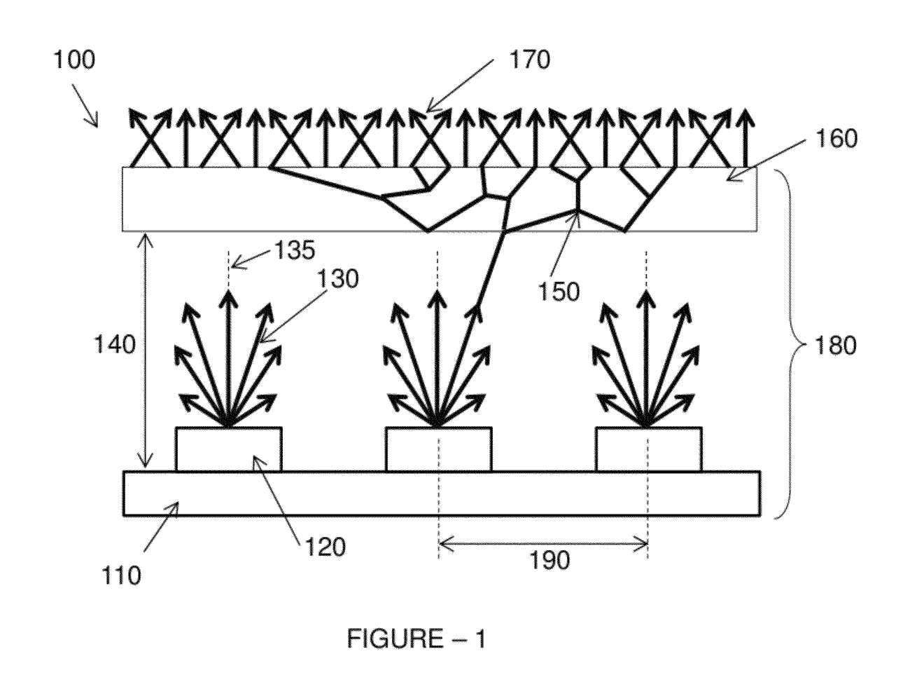

FIG. 1 provides a side view of a typical LED direct-lit backlight assembly 180, having a micro-particle scattering diffuser sheet 160 with a plurality of LEDs 120 which may be mounted in a planar 2-D fashion on one or more printed circuit boards (PCB) 110. In typical direct-lit backlight assemblies (especially for LCD applications) there are often more optically-functional layers than shown in FIG. 1, but these additional layers are not shown in FIG. 1 or in any other figures herein for at least the following reasons: for the sake of clarity, the actual number and type of additional optical layers can vary widely depending on the application, and the functionality of the exemplary embodiments do not necessarily require any other layers being present (although the performance of the exemplary embodiments may be enhanced by the presence of other optical layers). The design shown here is a typical design for common LED direct-lit LCD systems. An understanding of these designs will yield insight into the novelty and functionality of the subject invention.

In FIG. 1, and henceforth in this description, the light that is emitted by the LEDs 120 is depicted as rays 130 for convenience of illustration. It is common for LEDs to emit light in a spatial pattern that is predominately Lambertian, meaning that the intensity of the light is strongest in a direction along the LED axis 135 and then becomes weaker at other angles ‘Theta’ relative to the axis 135 according to the trigonometric function cosine(Theta). In this case the strongest rays of light 130 will travel in a direction which is near parallel to the axis 135 of each LED 120. Other rays of light 130 will travel in a direction which is not parallel to the axis 135 of the LED 120. Even for LEDs that do not exhibit a predominately Lambertian emission pattern the direction of the most intense light is often near the axis 135 of the LEDs 120, except for certain less-common LEDs that have been purposely designed in a different way. For typical LEDs it is especially the stronger on-axis light that should preferably be effectively homogenized so that its point-like intensity is not perceived by the viewer of the final display.

When light from an LED 120 enters a scattering diffuser sheet 160 it typically undergoes many iterations of ‘ray splitting’ 150 at each scatter event; the composite traces of many splitting events being reminiscent of a spider's web within the diffuser 160. A scattering event 150 typically takes place when a light ray strikes a micro-particle within the diffuser sheet 160. For simplicity and clarity each scatter event 150 is illustrated as being a 1-ray-in, 2-ray-out process, but in reality a scattering event can produce a vast spectrum of scattered rays in many directions. However, this level of detail is unnecessary to describe the basic methods of FIG. 1. When the diffuser sheet 160 is far enough from the LEDs 120 as determined by the ‘throw distance’ 140 then the light field emitted from the top of the diffuser 160 should be substantially homogenized as represented by the uniformly distributed rays 170. In these typical designs it is clear that a substantial amount of light scattering events within the diffuser 160 is essential to homogenizing the light 170. The backlight assembly 180 can perform adequately when the throw distance 140 is sufficiently large, which is predominately dependent on the spacing 190 between LEDs 120. The required throw distance 140 becomes proportionately larger as the LED spacing 190 becomes larger. In some cases the throw distance 140 can be slightly reduced by using a diffuser sheet 160 that has a higher density of scattering events 150. However, this approach is quite limited by geometric and scattering optics, as well as the fact that every scattering event typically incurs some amount of optical absorption. Therefore, a high density of scattering events within a traditional diffuser may lead directly to an undesirable loss of optical transmission and overall reduced power efficiency.

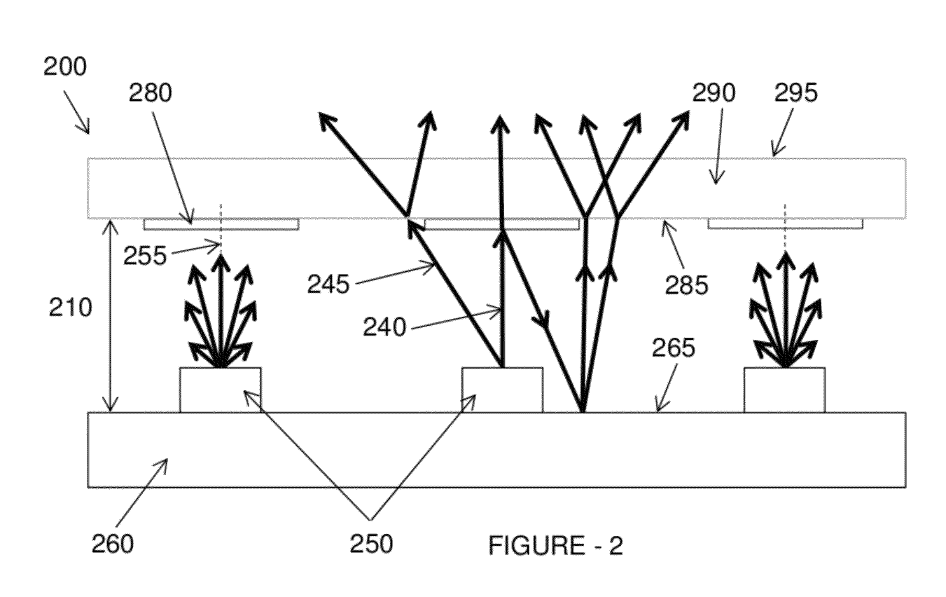

FIG. 2 provides a side view of a direct-lit backlight 200 using an exemplary embodiment of the diffuser device 290 incorporating shaped reflectors 280 used with a plurality of LEDs 250 which are mounted on a planar PCB 260 (or other suitable mounting substrate). In this embodiment, the diffusing device 290 is placed at a throw distance 210 above the LEDs 250. The diffusing device contains a shaped reflector 280 directly above each LED 250 that is preferably substantially aligned with the axis 255 of each LED 250. For clarity the shaped reflectors 280 are shown as having a perceptible thickness, but in actual fabrication their thickness may be imperceptible (for example, on the scale of microns), or even embedded into the base material of the diffuser 290. Placing the shaped reflectors 280 on the bottom surface 285 of the diffusing device 290 that faces the LEDs 250 has been found to be effective, but is not a requirement. Other embodiments could place the shaped reflectors 280 on the top surface 295 of the diffusing device 290 that is opposite the LEDs 250. Still other embodiments could implement a diffusing device 290 with multiple internal layers whereby the shaped reflectors 280 are placed within the diffusing device 290 (for example, between layers). Optionally the diffusing device 290 may be preceded and/or succeeded in the optical stack by one or more separate and distinct optical layers that may serve other useful functions including, but not limited to the ‘recycling’ of light as a function of emission direction, commonly known a brightness enhancement film (BEF). Alternatively, the ‘recycling’ of light as a function of polarization state, for example the ‘dual brightness enhancement film’ (DBEF) produced by 3M Vikuiti™. (St. Paul, Minn. www.3m.com) It should be understood that the various embodiments described herein possess an inherent flexibility that allows the shaped reflectors 280 to be located at any point within a potentially multilayer optical stack in a backlight assembly 200, whereby the particular location of the reflectors 280 may be advantageously tailored to a particular application.

As noted previously, the most intense portion of the light emitted from an LED 250 is typically that which is near parallel to the axis 255 of the LED, such as light ray 240. Thus, the shaped reflectors 280 may be predominately aligned with the axis 255 of the LEDs 250 so that this intense portion of the emitted light may be at least partially and perhaps totally reflected and scattered to homogenize the overall light output of the backlight assembly 200.

Particularly, light ray 240 is emitted from the LED 250 in a direction that is near parallel to the axis 255 of the LED 250. Light ray 240 may then contact a shaped reflector 280 where it is predominately reflected back towards the PCB 260. Upon contacting the front surface 265 of the PCB 260 the light is reflected again towards the diffusing device 290 where it may be further scattered and finally exit the top surface 295 of the diffusing device 290. To facilitate the light homogenization of the diffusing device 290 the bottom surface 285 of the diffusing device 290 may implement a textured or grated finish with the additional possibility that the shaped reflectors 280 also become textured and hence more effective at broadly scattering and homogenizing the light. Alternatively, a textured shaped reflector 280 may be obtained by the reflector fabrication process itself; for example, by adding micro-particles to paint. Additionally, the top surface 295 of the diffusing device 290 may implement a textured or grated finish for enhanced homogenization of light.

Further, traditional scattering micro-particles may be embedded within the body of the diffusing device 290. The base material of the diffusing device 290 may be comprised of plastic or glass or any other transparent or semi-transparent material. Some embodiments may use a milky-white plastic as the base material for the diffusing device 290. Other embodiments may use a sheet of glass which has one or more frosted and/or etched surfaces as the base material for the diffusing device 290.

Light 245 is emitted from the LEDs 250 in a direction that is not parallel to the axis 255 of the LEDs 250 and in this embodiment does not contact a shaped reflector 280. Instead, light 245 may simply be scattered by a textured surface finish and/or by internally scattering micro-particles within the base material of the diffusing device 290. Advantageously, the density of the scattering micro-particles that may be used in conjunction with the shaped reflectors could be much lower than that used in traditional prior-art diffusers that rely solely on micro-particle scattering for light diffusion, thereby increasing the overall optical transparency of the diffuser and permitting lower power consumption by the backlight assembly 200.

The size and pattern of the shaped reflectors 280 may be chosen to interact with light rays within a certain range of angles to the axis 255 of the LEDs 250. By way of example and not of limitation, the shaped reflector 280 may be large enough (or close enough to the LED 250) so as to intercept the majority of light travelling at +/−25 degrees relative to the axis 255 of an LED 250. In an alternative example, the shaped reflector 280 may be small enough (or far enough from the LED 250) so as to intercept the majority of light travelling at +/−5 degrees relative to the axis 255 of an LED 250. These parameters can be advantageously tailored to any particular application.

It is generally desired that the shaped reflectors 280 reflect less than 100% of the optical energy in the on-axis light rays which intersect them. For example, in some embodiments the shaped reflector 280 may only reflect 80% of the on-axis incident light ray energy while transmitting 20% (not accounting for any absorption). These properties can be advantageously tailored to any particular application depending on the geometry and materials used for the diffusing element 290 and the shaped reflectors 280. As discussed later, the reflection/transmission ratios may also vary across a shaped reflector itself, generally being highest near the center and lowest near the edges.

In some embodiments there may be no reflective material deposited outside the edges of the actual shaped reflectors 280. In other embodiments, reflective material may be deposited at relatively low densities (low reflectivity) across the entire bottom surface 285 of the diffusing device 290 with areas of medium to high density deposited at areas which are directly over an intended LED 250. This technique may be used to further enhance the homogenization properties of the diffuser 290 by forcing light rays such as 240 and 245 to bounce repeatedly between the bottom surface 285 of the diffusing device 290 and the top surface 265 of the PCB 260.

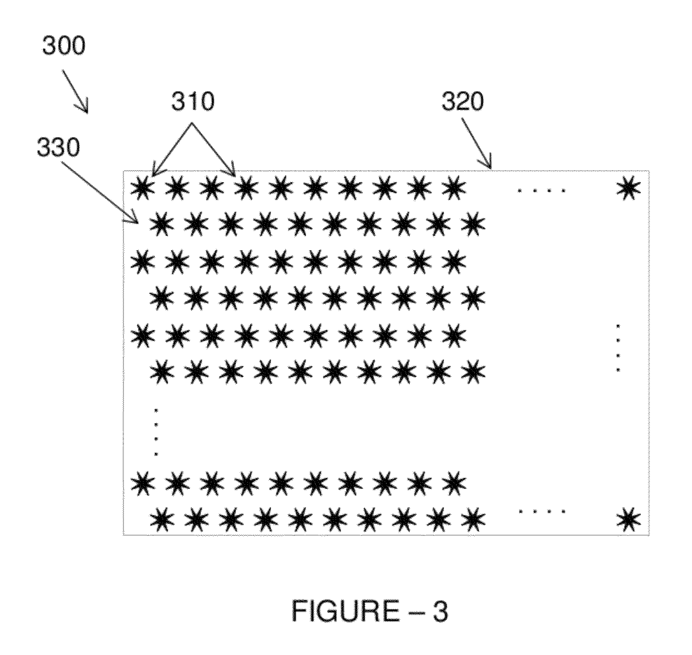

FIG. 3 is a bottom view (i.e., the side facing the LEDs) of one embodiment for distributing shaped reflectors 310 across the diffusing device 320. For clarity in this particular embodiment a simple eight-pointed star shape is used for the shaped reflectors 310. It is preferable that the center of each shaped reflector 310 is aligned with the axis of each LED. However, if a star or similar ‘soft-edged’ shape is used for the shaped reflectors 310 it has been found that the precision of alignment between the axis of the LEDs and the centers of the shaped reflectors 310 can be less critical. This represents a significant advantage in implementing the various embodiments in practical manufacturing situations. As discussed previously the surface regions 330 of the diffusing device 320 between shaped reflectors 310 may be optically smooth or may contain a light-scattering feature which may include but is not limited to surface texturing/etching and/or embedded particles.

In preferred embodiments, the shaped reflectors 310 possess qualities that reflect more of the intense on-axis LED light while reflecting less of the off-axis LED light. The result may provide a shaped reflector that exhibits a variable reflectivity across its shape, generally being more reflective in its center and less reflective near its edges.

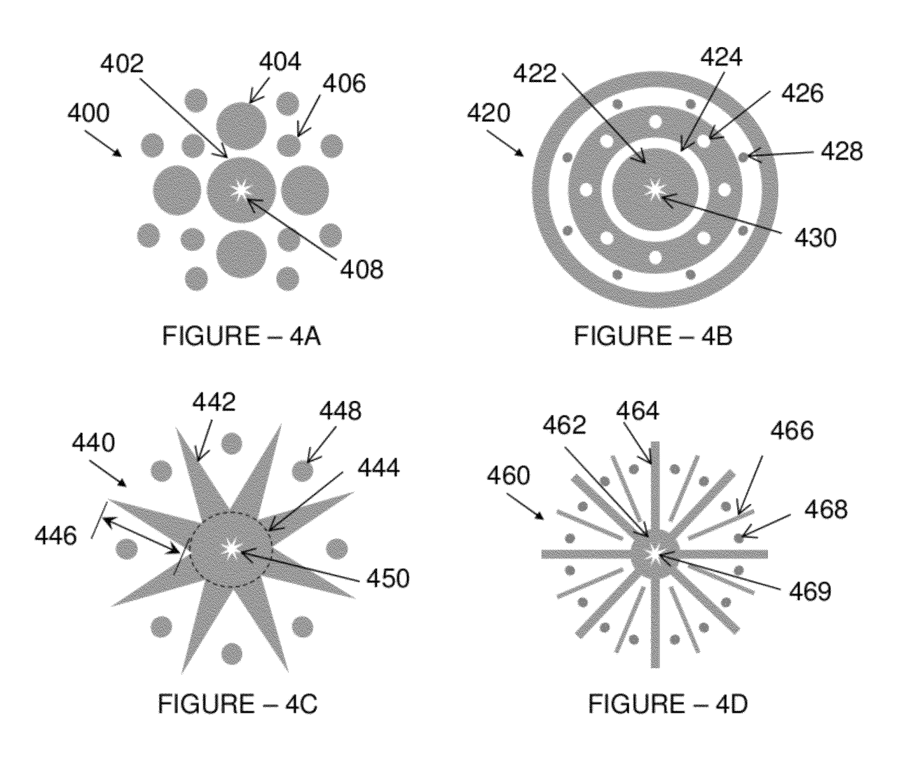

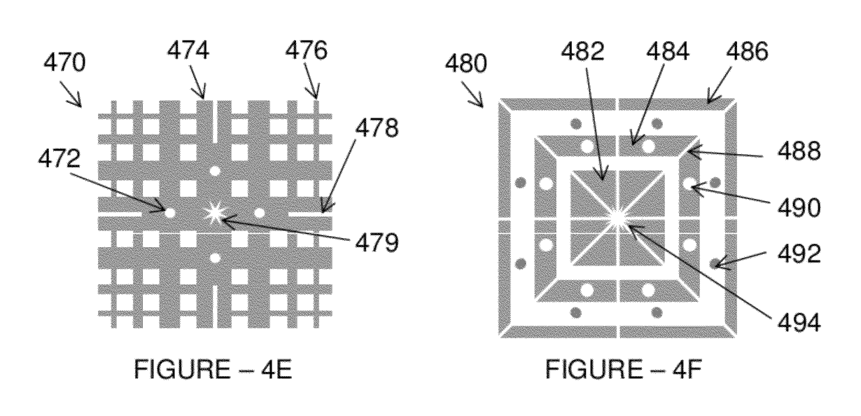

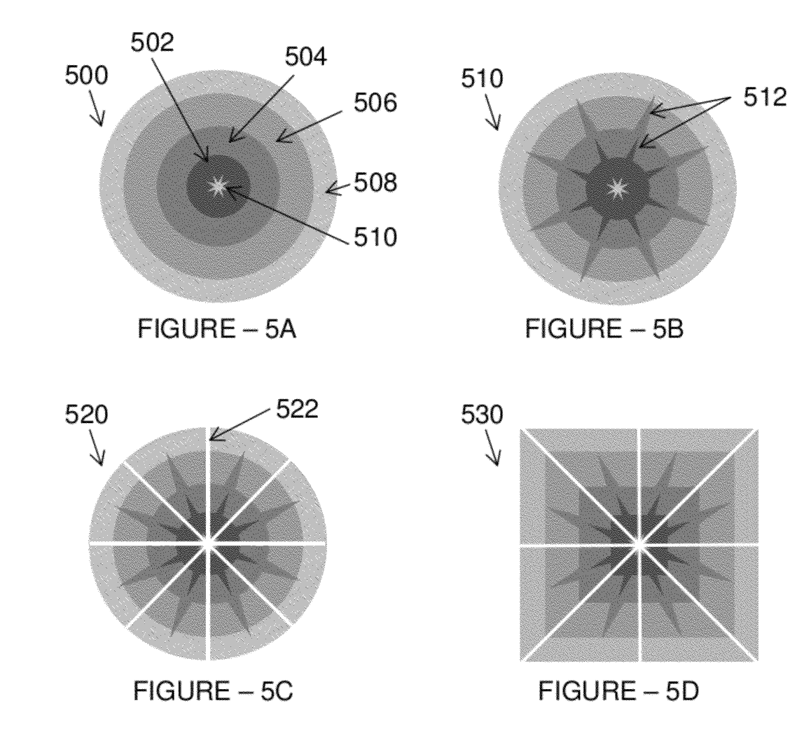

By way of example and not by way of limitation, FIGS. 4A-4F illustrate several embodiments of single-tone shaped reflectors. An example of a typical single-tone process is one-pass screen printing that applies a reflective material with constant reflectivity properties wherever it is applied, although as discussed earlier the preferred reflectivity of the material is generally less than 100%. Thus, as used herein the term ‘reflective’ does not necessarily imply a reflectivity of 100%. Variable reflectivity across an individual reflector is then achieved in an effective sense by spatially segmenting the reflector to create a composite of smaller reflector elements. Some shaped reflectors fabricated by a single-tone process may benefit from having additional light diffusion in the backlight system such as traditional micro-particle and/or surface etching/texture scattering, though advantageously, only milder forms of these traditional technologies may be required.

FIG. 4A illustrates a single-tone shaped reflector 400 that has an effective variable reflectivity comprised of many sub-element dots of varying diameter and spacing. In an exemplary embodiment of a direct-lit backlight, a shaped reflector 400 would preferably be suspended above each LED as previously discussed. In other words, in this embodiment the shaped reflector 400 would be replicated on the diffuser device in a one-to-one correspondence to the number and location of LEDs in the backlight. Within the composite reflector 400 is a relatively large central dot 402 which reflects as much of the on-axis LED light as desired. Smaller dots 404 reflect less of the off-axis LED light, and then even smaller interspersed dots 406 help to generate a smoother effective variation in the change of reflectivity versus radial distance from the center dot 402. Optionally, one or more small openings may be provided within the central dot 402, such as the star-shaped opening 408, in order to provide additional control over the exact amount of on-axis light that is transmitted. For clarity the illustrated composite reflector 400 consists of a relatively simple pattern of sub-elements, but it is quite easy to envision a virtually endless number of pattern and sub-element variations that build upon the basic theme of 400 that fall within the spirit and scope of the exemplary embodiments of the invention. The sub-element patterns suggested by 400 and its myriad variations may be advantageously tailored to any particular application.

FIG. 4B illustrates a shaped reflector 420 that has an effective variable reflectivity comprised of a central reflective disc and one or more outlying reflective rings of varying diameter and width, where the reflective material is present in a single tone. In a exemplary embodiment of a direct-lit LED backlight there would exist a shaped reflector 420 suspended above each LED as previously discussed; in other words, the composite reflector 420 would be replicated on the diffuser device in a one-to-one correspondence to the number and location of LEDs in the backlight. Within the composite reflector 420, a central reflective disc 422 reflects as much of the on-axis LED light as desired. Outside of this disc 422 is a relatively narrow transparent ring 424 that allows some of the nearly on-axis light to pass through. Progressing further away from the center of disc 422, the width of the reflective rings becomes narrower, thereby progressively allowing more of the off-axis light to be directly transmitted. Optionally, small transmitting holes 426 may be included within the reflective rings and/or small reflecting discs 428 may be included within the transmitting rings to help generate a smoother effective variation in the change of reflectivity versus radial distance from the center of disc 422. Also optionally, one or more small openings may be provided within the central disc 422, such as the star-shaped opening 430, in order to provide additional control over the exact amount of on-axis light that is transmitted. For clarity the illustrated composite shaped reflector 420 consists of a relatively simple pattern of sub-elements, but it is quite easy to envision a virtually endless number of pattern and sub-element variations that build upon the basic theme of 420 that fall within the spirit and scope of the exemplary embodiments of the invention. The sub-element patterns suggested by 420 and its myriad variations may be advantageously tailored to any particular application.

FIG. 4C illustrates a shaped reflector 440 that has an effective variable reflectivity comprised of a star-like shape, where the reflective material is present in a single tone. Although a star-like reflector may be considered as a single entity, in practice it is more appropriately described as a composite shape consisting of a central disc surrounded by multiple spokes. The reflector 440 can therefore be characterized by the diameter of its central disc 444, the number of spokes 442, and the length of the spokes 446. In a exemplary embodiment of a direct-lit LED backlight there would exist a shaped reflector 440 suspended above each LED as previously discussed. Within the composite reflector 440 the central disc 444 reflects as much of the on-axis LED light as desired. Outside of the central disc 444 the tapered nature of the spokes 442 progressively allows more of the off-axis light to be directly transmitted. Optionally, small reflecting discs 448 may be interspersed between the spokes 442 to help generate a smoother effective variation in the change of reflectivity versus radial distance from the center of disc 444. Also optionally, one or more small openings may be provided within the central disc 444, such as the star-shaped opening 450, in order to provide additional control over the exact amount of on-axis light that is transmitted. For clarity the illustrated composite reflector 440 consists of a relatively simple pattern of sub-elements, but it is quite easy to envision a virtually endless number of pattern and sub-element variations that build upon the basic theme of 440 that fall within the spirit and scope of the exemplary embodiments of the invention. The sub-element patterns suggested by 440 and its myriad variations may be advantageously tailored to any particular application.

FIG. 4D illustrates a shaped reflector 460 that has an effective variable reflectivity comprised of a central disc and multi-spoke pattern, where the reflective material is present in a single tone. This shaped reflector 460 is similar to the star-like reflector 440 shown in FIG. 4C, but may have advantages in certain applications. The reflector 460 is characterized by the diameter of its central disc 462, the number of spokes 464, and the length of the spokes 464. In an exemplary embodiment of a direct-lit LED backlight there would exist a shaped reflector 460 suspended above each LED as previously discussed. Within the composite reflector 460 the central disc 462 reflects as much of the on-axis LED light as desired. Outside of the central disc 462 the reflective spokes 464 progressively allow more of the off-axis light to be directly transmitted. Optionally, additional reflective spokes 466 may be fabricated between the main spokes 464. Also optionally, small reflecting dots 468 may be interspersed between the spokes 464 and 466 to help generate a smoother effective variation in the change of reflectivity versus radial distance from the center of disc 462. Also optionally, one or more small openings may be provided within the central disc 444, such as the star-shaped opening 469, in order to provide additional control over the exact amount of on-axis light that is transmitted. For clarity, the illustrated composite reflector 460 consists of a relatively simple pattern of sub-elements, but it is quite easy to envision a virtually endless number of pattern and sub-element variations that build upon the basic theme of 460 that fall within the spirit and scope of the exemplary embodiments of the invention. The sub-element patterns suggested by 460 and its myriad variations may be advantageously tailored to any particular application.

FIG. 4E illustrates a shaped reflector 470 that has an effective variable reflectivity comprised of a grid-like pattern of reflective lines, where the reflective material is present in a single tone. The reflector 470 is characterized by the length and number of grid lines and their varying width, being widest in the mid-sections 474 and narrowest at the edges 476. In an exemplary embodiment of a direct-lit LED backlight there would exist a shaped reflector 470 suspended above each LED as previously discussed. As an alternative embodiment, the entire diffusing device may be covered with the grid-like pattern, where only the areas directly above an LCD contain grid lines having the largest widths.

For the composite reflector 470, the center of the pattern reflects as much of the on-axis LED light as desired. Away from the center of the pattern the amount of surface area that is rendered reflective is progressively reduced which allows more of the off-axis light to be directly transmitted. Optionally, small transmitting holes 472 may be added to the grid lines for additional control of the variable reflectivity. Also optionally, transmitting slots 478 may be added to the grid lines for additional control of the variable reflectivity at the edges. Also optionally, one or more small openings may be provided at the center of the pattern (such as the star-shaped opening 479) in order to provide additional control over the exact amount of on-axis light that is transmitted. For clarity, the illustrated composite reflector 470 consists of a relatively simple pattern of sub-elements, but it is quite easy to envision a virtually endless number of pattern and sub-element variations that build upon the basic theme of 470 that fall within the spirit and scope of the exemplary embodiments of the invention. The sub-element patterns suggested by 470 and its myriad variations may be advantageously tailored to any particular application.

FIG. 4F illustrates a shaped reflector 480 that has an effective variable reflectivity comprised of a central reflective square and one or more outlying reflective rings of varying size and width where the reflective material is present in a single tone. The reflector 480 is essentially a square version of the circle-based reflector 420 shown in FIG. 4B. In an exemplary embodiment of a direct-lit LED backlight there would exist a shaped reflector 480 suspended above each LED as previously discussed. Within the composite reflector 480 a central reflective square 482 reflects as much of the on-axis LED light as desired. Outside of this square 482 is at least one reflective ring 484 separated from the central square 482 by a transmitting gap that allows some of the nearly on-axis light to pass through. Continuing further outward the width of the reflective rings (if any, such as 486) become relatively narrower while the gap between the rings become relatively wider, thereby progressively allowing more of the off-axis light to be directly transmitted. Optionally, transmitting stripes 488 may be added to the overall pattern for further control of the reflectivity. Also optionally, small transmitting holes 490 may be included within the reflective rings and/or small reflecting discs 492 may be included within the transmitting rings to help generate a smoother effective variation in the change of reflectivity versus distance from the central square 482. Also optionally, one or more small openings may be provided within the central square 422, such as the star-shaped opening 494, in order to provide additional control over the exact amount of on-axis light that is transmitted. For clarity the illustrated composite reflector 480 consists of a relatively simple pattern of sub-elements, but it is quite easy to envision a virtually endless number of pattern and sub-element variations that build upon the basic theme of 480 that fall within the spirit and scope of the exemplary embodiments of the invention. The sub-element patterns suggested by 480 and its myriad variations may be advantageously tailored to any particular application.

As mentioned in the descriptions of each of the shaped reflectors in FIGS. 4A-4F relatively simple versions of the reflector patterns have been illustrated for clarity. Increasing the complexity to improve the performance of the illustrated patterns is specifically within the spirit and scope of the exemplary embodiments of the invention. In view of this description, those skilled in the art may derive other means for generating an effectively variable reflectivity within the area of a one-tone reflector that fall within the spirit and scope of the exemplary embodiments of the invention. In addition, one may envision hybrid combinations of the patterns presented in FIGS. 4A-4F that fall within the spirit and scope of the exemplary embodiments of the invention.

By way of example and not by way of limitation, FIGS. 5A-5D illustrate several means of effectively implementing multi-tone shaped reflectors (possibly using fabrication processes that are multi-tone). An exemplary type of multi-tone process is multi-pass screen printing that can produce reflective areas of distinctly higher reflectivity by building up multiple layers of reflective material. Variable reflectivity across an individual reflector is achieved with a multi-tone process in a true sense by spatially segmenting the reflector to into areas of discretely varying reflectivity. In FIGS. 5A-5D, the darker regions of a reflector shape represent higher values of reflectivity. Some shaped reflectors fabricated by a multi-tone process may benefit from having additional light diffusion in the backlight system such as provided by traditional micro-particle and/or surface texture scattering, though advantageously much milder forms of these traditional technologies are required.

FIG. 5A illustrates a shaped reflector 500 that has an effective variable reflectivity comprised of a central reflective disc of relatively high reflectivity that is surrounded by at least one larger disc that has a relatively lower reflectivity. In an exemplary embodiment of a direct-lit LED backlight there would exist a shaped reflector 500 suspended above each LED as previously discussed. Within the composite reflector 500 a central reflective disc 502 reflects as much of the on-axis LED light as desired. Surrounding the disc 502 is an annular region 504 with somewhat less reflectivity than that of the central disc 502, which allows more of the off-axis LED light to pass through. This process may be repeated at will, as illustrated with annular regions 506 and 508, thereby progressively allowing more of the off-axis LED light to be directly transmitted in proportionality to the angle of light rays from the optical axis of the LED. Optionally, one or more small patterns with lower reflectivity may be provided within the central disc 502, such as the star-shaped pattern 510 in order to provide additional control over the exact amount of on-axis light that is transmitted, or even in the annular regions 504-508. For clarity the illustrated composite reflector 500 consists of a relatively simple pattern of sub-elements, but it is quite easy to envision the addition of other sub-element features such as arrays of holes or gridlines for additional control of reflected LED light that, building upon the basic theme of 500, fall within the spirit and scope of the exemplary embodiments of the invention. The sub-element patterns suggested by 500 and its myriad variations may be advantageously tailored to any particular application.

FIG. 5B illustrates a shaped reflector 510 that embodies the same basic concepts as the reflector shown in FIG. 5A with the addition of spokes 512 to one or more of the reflective regions. The spokes 512 may be used to provide even further control of the variable reflectivity away from the optical axis of the LED. It is easy to envision the addition of other sub-element features such as arrays of holes or gridlines for additional control of reflected LED light that, building upon the basic theme of 510, fall within the scope and spirit of the exemplary embodiments. The sub-element patterns suggested by 510 and its myriad variations may be advantageously tailored to any particular application.

FIG. 5C illustrates a shaped reflector 520 that embodies the same basic concepts as the reflector shown in FIG. 5B with the addition of cut lines 522 having little or no reflectivity. The cut lines 522 may be used to provide even further control of the variable reflectivity away from the optical axis of the LED. It is easy to envision the addition of other sub-element features such as arrays of holes or gridlines for additional control of reflected LED light that, building upon the basic theme of 520, fall within the scope and spirit of this embodiment. The sub-element patterns suggested by 520 and its myriad variations may be advantageously tailored to any particular application.

FIG. 5D illustrates a shaped reflector 530 that is essentially a square, or more generally rectangular, version of the reflector shown in FIG. 5C. It is easy to envision the addition of other sub-element features such as arrays of holes or gridlines for additional control of reflected LED light that, building upon the basic theme of 530, fall within the scope and spirit of the exemplary embodiments of the invention. The sub-element patterns suggested by 530 and its myriad variations may be advantageously tailored to any particular application.

As mentioned in the descriptions of each of the shaped reflectors in FIGS. 5A-5D, relatively simple versions of the reflector patterns have been illustrated for clarity. Increasing the complexity to improve the performance of the illustrated patterns is within the spirit and scope of the exemplary embodiments of the invention. For those skilled in the art there will be other means for generating an effectively variable reflectivity within the area of a reflector that fall within the spirit and scope of the exemplary embodiments of the invention. In addition, one may easily envision hybrid combinations of the patterns presented in FIGS. 5A-5D that fall within the spirit and scope of the exemplary embodiments of the invention.

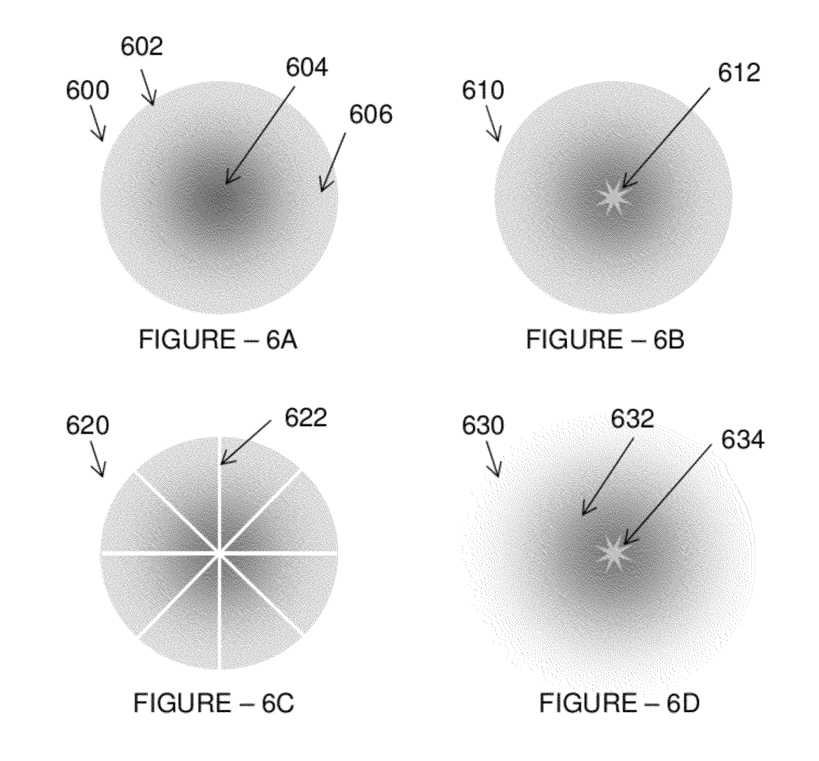

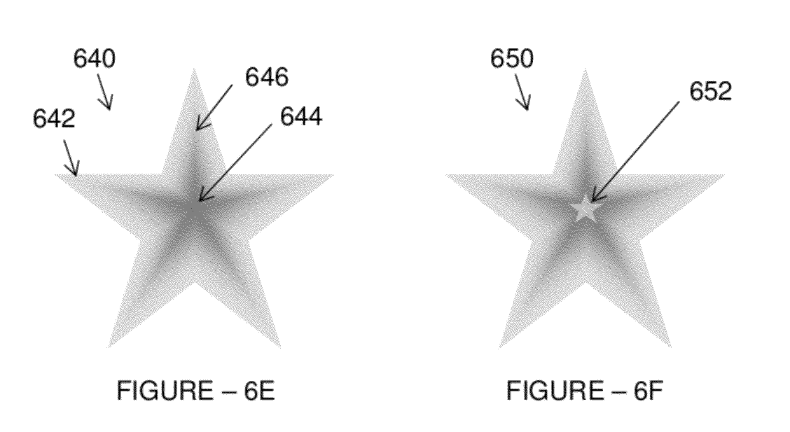

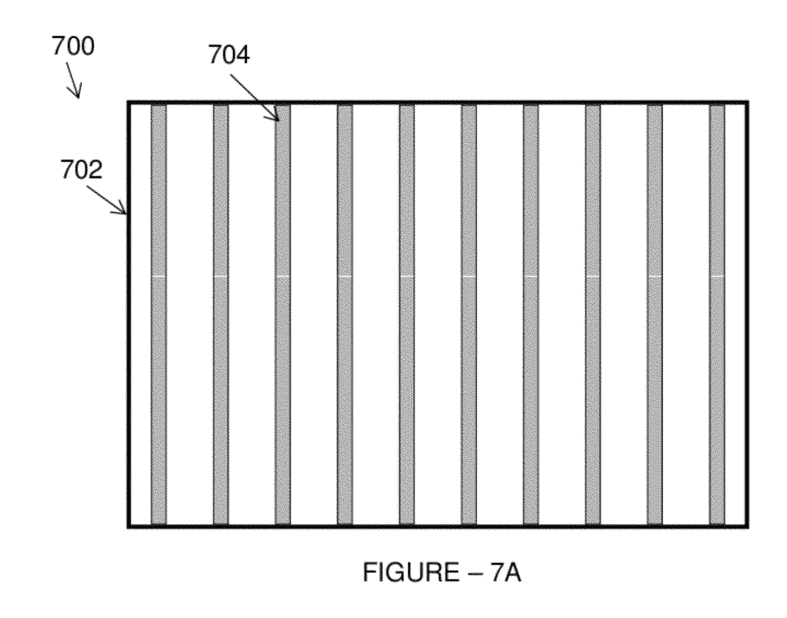

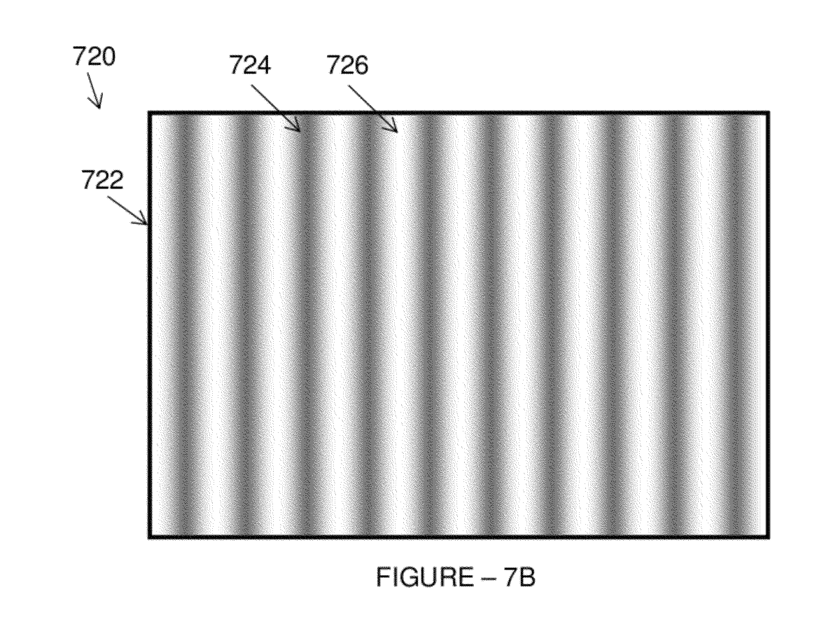

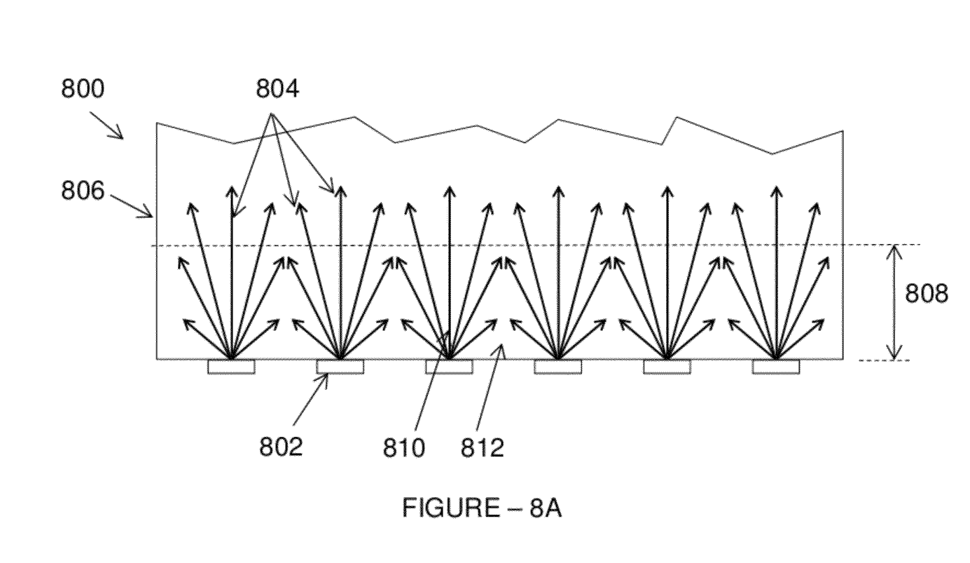

By way of example and not by way of limitation, FIGS. 6A-6D illustrate several means of effectively implementing variable-reflectivity shaped reflectors using a gradient-tone. Example gradient-tone processes may include spraying and certain vapor-deposition processes. Gradient-tone processes may also be effectively achieved by fine-resolution masks (for example, screen printing) that mimic a smoothly varying process. In general, a gradient-tone process may offer better performance than either single-tone or multi-tone fabrication processes, although it may be harder and/or more costly to achieve. The light emitted by an LED typically varies in a smooth manner, so a preferable way to homogenize this light is by a complimentary smoothly varying process. Owing to this, the apparent structural complexity of a gradient-tone reflector may appear relatively simple compared to a reflector fabricated by a single-tone or multi-tone fabrication process. Variable reflectivity across an individual reflector is achieved with a gradient-tone process in a true sense by smoothly varying the reflectivity, generally having a reflectivity ‘profile’ that is higher in the center and lower near the edges. However, the reflectivity profile may be advantageously tailored to the particular emission properties of any LED. In FIGS. 6A-6F, the darker regions of a reflector shape represent higher values of reflectivity. Shaped reflectors having a gradient-tone may also benefit from having additional light diffusion in the backlight system such as provided by traditional micro-particle and/or surface texture scattering, though much milder forms of these traditional technologies may be used.

FIG. 6A illustrates a shaped reflector 600 that has a smoothly variable reflectivity comprised of a reflective disc having a gradient-tone. In a exemplary embodiment of a direct-lit LED backlight there would exist a shaped reflector 600 suspended above each LED as previously discussed; in other words, the reflector 600 would preferably be replicated on the diffuser device in a one-to-one correspondence to the number and location of LEDs in the backlight. The reflector 600 has a generally circular shape 602 with the peak reflectivity occurring at the center of the disc 604 and tapering off near the edges of the disc 606, as would typically be used in conjunction with LEDs that emit in a Lambertian pattern. However, the reflectivity profile may be particularly tailored to other LEDs that do not emit in a Lambertian pattern. In addition to the reflectivity profile, the magnitude of the reflectivity at the center 604 and at the edge 602 may be tailored for particular applications. For clarity the illustrated reflector 600 consists of a very simple shape, but it is quite easy to envision the addition of other sub-element features such as arrays of holes or gridlines for additional control of reflected LED light that, building upon the basic theme of 600, fall within the spirit and scope of the exemplary embodiments of the invention. Hence, the pattern shape and reflectivity profile generally suggested by 600 and its myriad variations may be advantageously tailored to any particular application.

FIG. 6B illustrates a shaped reflector 610 that embodies the same basic concepts as the reflector shown in FIG. 6A with the addition of at least one sub-element shape such as the star shape 612. The purpose of the star shape 612 is to provide a smaller feature(s) of relatively higher or lower reflectivity to provide even further control of the variable reflectivity away from the optical axis of the LED. Hence, the basic and sub-element pattern shapes and reflectivity profile generally suggested by 610 and its myriad variations may be advantageously tailored to any particular application.

FIG. 6C illustrates a shaped reflector 620 that embodies the same basic concepts as the reflector shown in FIG. 6A with the addition of ‘spoke-lines’ 622. The purpose of the spoke-lines 622 is to provide smaller feature(s) of relatively higher or lower reflectivity to provide even further control of the variable reflectivity away from the optical axis of the LED. Hence, the basic and sub-element pattern shapes and reflectivity profile generally suggested by 620 and its myriad variations may be advantageously tailored to any particular application.

FIG. 6D illustrates a shaped reflector 630 that embodies the same basic concepts as the reflector shown in FIG. 6A with the provision that the reflectivity at the edge of the disc falls to near zero; e.g., there is not a clearly defined edge on the reflector. Optionally, at least one sub-element shape such as the star shape 634 may be provided. The star shape 634 may provide a smaller feature(s) of relatively higher or lower reflectivity to provide even further control of the variable reflectivity away from the optical axis of the LED. Hence, the basic and sub-element pattern shapes and reflectivity profile generally suggested by 630 and its myriad variations may be advantageously tailored to any particular application.

FIG. 6E illustrates a shaped reflector 640 that embodies a similar concept as the reflector shown in FIG. 6A except that the basic shape is a star rather than a circle. Similar to some of the previously described embodiments, the peak reflectivity would preferably occur near the center 644 and falls off gradually along the center of each spoke 646 of the star, and also at the edges 642 of the star, as would typically be used in conjunction with LEDs that emit in a Lambertian pattern. However, the actual reflectivity profile may be particularly tailored to other LEDs that do not emit a Lambertian pattern. In addition to the reflectivity profile, the number and length of the spokes on the star may be tailored for particular applications. For clarity the illustrated reflector 640 consists of a very simple shape, but it is quite easy to envision the addition of other sub-element features such as arrays of holes or gridlines for additional control of reflected LED light that, building upon the basic theme of 640, fall within the spirit and scope of the exemplary embodiments of the invention. Hence, the basic pattern shape and reflectivity profile generally suggested by 640 and its myriad variations may be advantageously tailored to any particular application.

FIG. 6F illustrates a shaped reflector 650 that embodies a similar concept as the reflector shown in FIG. 6E with the addition of at least one sub-element shape such as the star shape 652. The star shape 652 may provide a smaller feature(s) of relatively higher or lower reflectivity to provide even further control of the variable reflectivity away from the optical axis of the LED. Hence, the basic and sub-element pattern shapes and reflectivity profile generally suggested by 650 and its myriad variations may be advantageously tailored to any particular application.

As mentioned in the descriptions of each of the shaped reflectors in FIGS. 6A-6F, relatively simple versions of the reflector patterns have been illustrated for clarity. Increasing the complexity to improve the performance of the illustrated patterns is within the spirit and scope of the exemplary embodiments of the invention. For those skilled in the art there will be other derivations for generating a variable reflectivity within the area of a reflector using a gradient-tone that would fall within the spirit and scope of the exemplary embodiments of the invention. In addition, one may easily envision hybrid combinations of the patterns presented in FIGS. 6A-6F that fall within the spirit and scope of the exemplary embodiments of the invention.

FIGS. 1-6 showed the application of an exemplary embodiment within a 2-D LED array direct-lit backlight assembly, but various other embodiments are equally applicable to direct-lit backlight assemblies that employ fluorescent tubes.

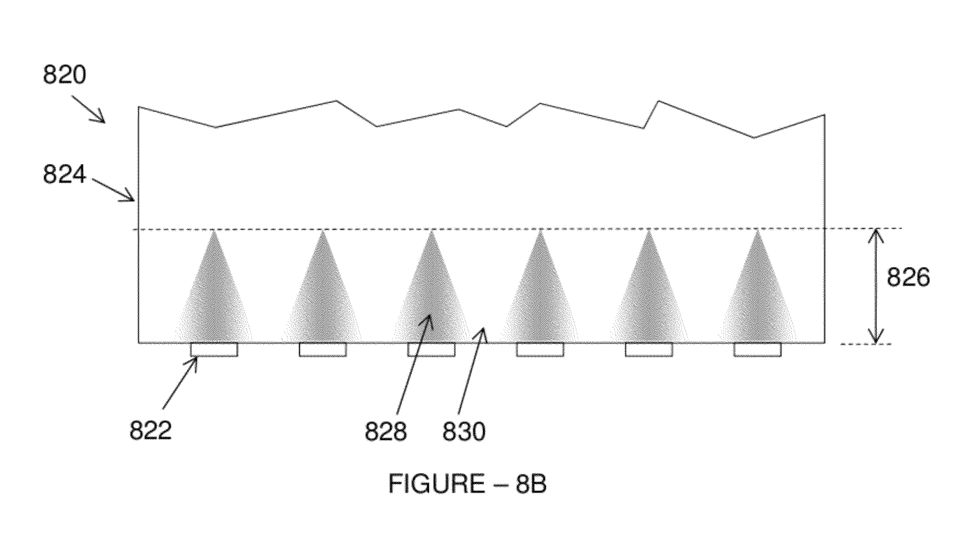

FIG. 7A illustrates a typical arrangement of fluorescent tubes 704 in a direct-lit backlight assembly 702. The tubes 704 typically run from one edge of the assembly to the opposite edge, and the number of tubes that are used is generally dictated by the required brightness of the LCD or any other type of display.

By way of example and not by way of limitation, FIG. 7B illustrates one means of effectively implementing variable-reflectivity shaped reflectors using gradient-tones for use with direct-lit fluorescent tube backlights such that shown in FIG. 7A. As with the case of the direct-lit LED backlight there is also here one reflector per light source; in this case one reflector 724 per fluorescent tube. Hence, each reflector 724 is essentially a stripe that is suspended above each tube for the full length of the tube. In this embodiment, the darker regions of the reflector shape 724 represent higher values of reflectivity. The peak reflectivity of each reflector 724 should preferably occur directly above each tube, and then tapers to low, or perhaps zero, reflectivity in the area 726 between the tubes. The peak reflectivity above each tube and the rate of decrease to the mid-point between tubes may be tailored for particular applications. It is easy to envision how any of the reflectors fabricated by single-tone, multi-tone, or gradient-tone fabrication processes as illustrated by example in FIGS. 4-6 may be adapted to the present case of direct-lit fluorescent tube backlight assemblies with all of the features and advantages described therein.

FIGS. 1-7 described a direct-lit backlight assembly, but various embodiments are equally applicable to edge-lit backlight assemblies.

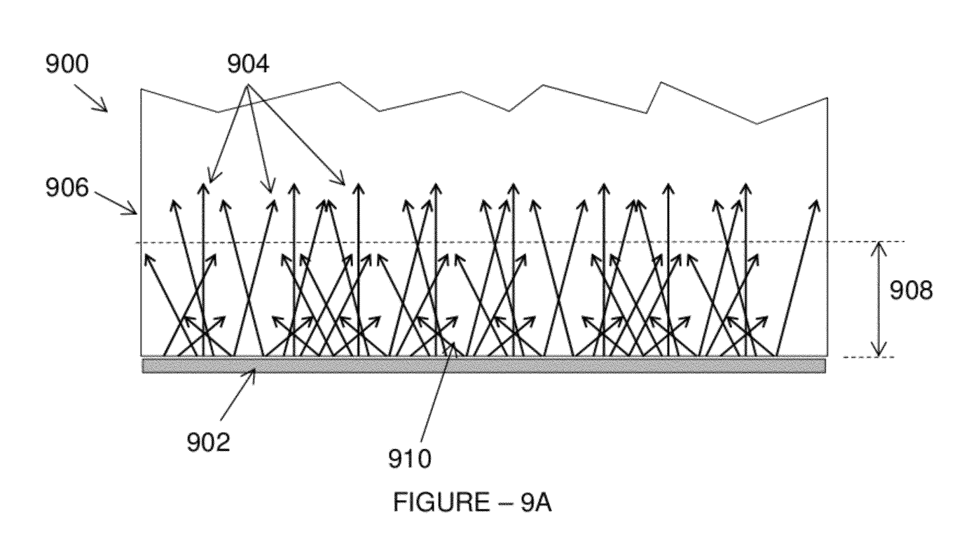

FIG. 8A illustrates a portion of a typical arrangement of an LED edge-lit backlight assembly in a top view (i.e., from the perspective a person viewing the final display). A row of LEDs 802 emit rays of light 804 into a typically plastic or glass plate 806 that is commonly known as a light guide. Through various extraction features the light eventually exits the light guide normal to the top surface of the light guide (i.e., out of the page of FIG. 8A). Analogous to the throw distance previously discussed in direct-lit backlights there is a certain distance 808 before the light from neighboring LEDs 802 has sufficiently overlapped one another as to produce a predominately uniform distribution of light within the lightguide. Near the LEDs 802 there are typically ‘hot’ spots 810 directly in front of the LEDs and ‘dark’ spots 812 between the LEDs; this effect is commonly referred to as ‘headlighting’. The effects of headlighting can be somewhat reduced by decreasing the distance between LEDs, but this is not always a cost effective or technically viable solution. However, an exemplary embodiment of the invention can overcome this problem by preferentially reflecting light from the hot spots 810 into the dark spots 812.

By way of example and not by way of limitation, FIG. 8B illustrates one means of effectively implementing variable-reflectivity shaped reflectors using gradient-tones for use with edge-lit LED backlights such as that shown in FIG. 8A. As with the case of the direct-lit LED backlight there is also here one reflector 828 per LED 822. In FIG. 8B the darker regions of the reflector shape may represent higher values of reflectivity. In this embodiment, headlighting may be reduced or eliminated by making the reflectivity higher on the axis of each LED 822 and lower away from it, and tapering the reflector down to a point at or near the distance 826 at which point the light from neighboring LEDs 822 has sufficiently overlapped. It is easy to envision how any of the reflectors as illustrated by example in FIGS. 4-6 (single-tone, multi-tone, or gradient-tone) may be adapted to the present case of edge-lit LED backlight assemblies 820 with all of the features and advantages described therein.

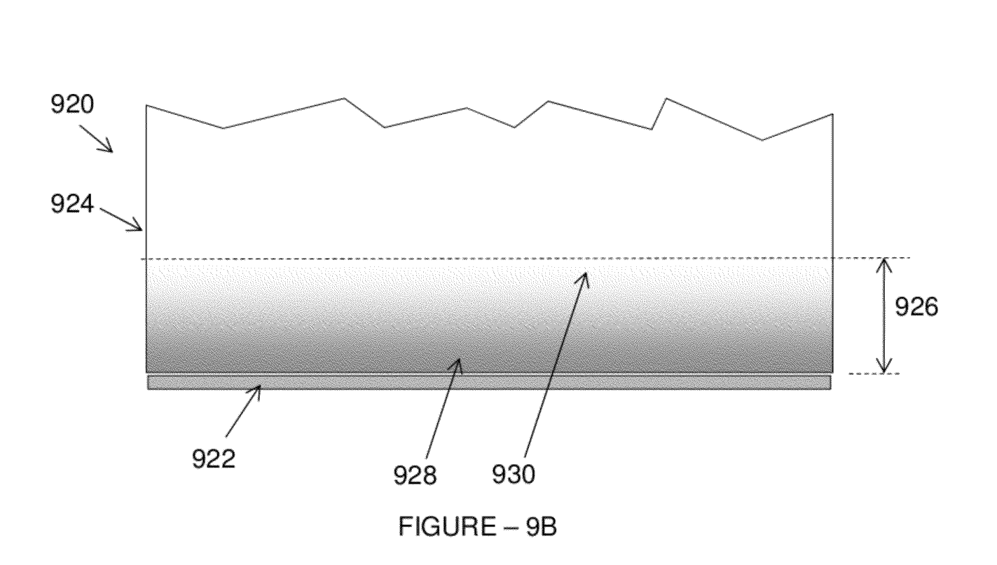

FIG. 9A illustrates a portion of a typical arrangement of a fluorescent tube edge-lit backlight assembly in a top view (i.e., from the perspective a person viewing the final display). A fluorescent tube 902 emits rays of light 904 into a typically plastic or glass light guide 906. Unlike LEDs, the light emitted by a fluorescent tube 902 is not a point-like source but is instead predominately uniform along its length as suggested by the random light rays 904. Analogous to the throw distance previously discussed in direct-lit backlights there is a certain distance 908 before the light becomes sufficiently mixed and predominately uniform. Undesirably, near the fluorescent tube 902 the light typically appears much stronger in an effect commonly called ‘edge glow’ that is analogous to the headlighting effect previously discussed with edge-lit LED backlights. However, an exemplary embodiment of the invention can overcome this problem by preferentially reflecting light near the fluorescent tube back into the light guide.

By way of example and not by way of limitation, FIG. 9B illustrates one means of effectively implementing a variable-reflectivity shaped reflector using a gradient-tone for use with edge-lit fluorescent tube backlights such as the type that is shown in FIG. 9A. Similar to some of the previous embodiments, there is also here one reflector per fluorescent tube; in this case just one tube and one reflector. The reflector has higher reflectivity near the fluorescent tube 928 and then tapers off to lower, or perhaps zero, reflectivity at an optimal distance 926 after which distance the reflector may no longer be needed for the purpose of light homogenization. In FIG. 9B the darker regions 928 of the reflector may represent higher values of reflectivity. The peak reflectivity 928 and the rate of decrease out to distance 926 may be tailored to particular applications to effectively eliminate edge glow. It is easy to envision how any of the reflectors as illustrated by example in FIGS. 4-6 (single-tone, multi-tone, or gradient-tone) may be adapted to the present case of edge-lit fluorescent backlight assemblies with all of the features and advantages described therein.

For the various embodiments described herein, the material used to create the shaped reflectors would preferably have low optical absorption properties (in order to increase the optical efficiency). There exists a great deal of flexibility and options in how the shaped reflectors may be fabricated onto the base material. For example and not by way of limitation, common reflector materials include paint, ink, metals, and dielectrics. If paint or ink is used it may be opaque or translucent and may be white or another highly-reflective color. Another exemplary method would be vapor deposition. In addition, various printing processes, including but not limited to: lithography, screen printing, seriography, and inkjet printing can also be used to deposit the reflector materials. Additionally, reflective metallic particles could be directly embedded into the base material. Further, the techniques of nano-optics, photonic crystals, and metamaterials may also be used to provide high efficiency optical reflectors with enhanced properties. Still further, chemical etching, sandblasting, and laser ablation techniques can be used to form the shaped reflector as a textured portion of the diffusing device.

To facilitate the reflection of the light off the front surface of the PCB, the front surface of the PCB may be constructed so that it is highly reflective. For example and not by way of limitation, the front surface may contain white paint, white ink, deposited metals, deposited dielectrics, nano-optics, photonic crystals, and/or metamaterials. Further, to facilitate the homogenization of light the front surface may contain a textured finish, or the reflective coating may contain dispersive particles.

As mentioned above, some embodiments may use a diffusing device that contains multiple layers. For example, a base substrate may have a texture layer on the top and bottom with an additional layer (or layers) comprising the shaped reflectors. Still further, the reflectors may be deposited on multiple layers and then bonded together. In reference to the embodiment shown in FIGS. 5A, a first layer may contain central disc 502, a second layer contains annular region 504, a third layer contains annular region 506, and a fourth layer contains annular region 508. Each layer can be placed atop one another in order to create the three-dimensional composite shaped reflector 500. Thus, shaped reflectors may also be simultaneously printed on more than one surface in a multi-layer configuration, providing yet another degree-of-freedom for optimization.

As discussed above, the embodiments herein may also be used with static advertising displays (ex. a backlit photograph or printed image) and these can use any type of illumination source (LED, fluorescent, electroluminescent, etc.) and may be direct-lit, edge-lit, or any combination thereof. Further, the embodiments herein can be used with common indoor/outdoor spatial lighting applications (i.e. office/interior lighting, effects lighting, outdoor lighting, etc.). Using the embodiments herein with these lighting assemblies can reduce the overall thickness and/or size of the assembly while maintaining a uniform distribution of light.

Having shown and described some exemplary embodiments of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention.

We claim:

1. An assembly for diffusing a plurality of light sources, the assembly comprising:
a diffusing device placed adjacent to the plurality of light sources; and
a plurality of shaped reflectors placed on the diffusing device where a shaped reflector is positioned adjacent to each light source.

2. The diffusing assembly of claim 1 wherein:
the light sources are LEDs having a central axis and
each shaped reflector is substantially aligned with the central axis of the corresponding LED.

3. The diffusing assembly of claim 1 wherein:
the light sources are fluorescent tubes and
each shaped reflector is positioned parallel to the length of the fluorescent tube.

4. The diffusing assembly of claim 3 wherein:
the shaped reflector has a varying amount of reflectivity with the highest amount of reflectivity being directly above the tube.

5. The diffusing assembly of claim 1 wherein:
the light sources are oriented with the diffusing device in a direct-lit fashion.

6. The diffusing assembly of claim 1 wherein:
the light sources are oriented with the diffusing device in an edge-lit fashion.

7. The diffusing assembly of claim 1 wherein:
the shaped reflector is single-tone.

8. The diffusing assembly of claim 1 wherein:
the shaped reflector is multi-tone.

9. The diffusing assembly of claim 1 wherein:
the shaped reflector is gradient-tone.

10. The diffusing assembly of claim 1 further comprising:
a plurality of light-scattering particles within the diffusing device.

11. The diffusing assembly of claim 1 wherein:
the shaped reflector has a generally circular shape.

12. The diffusing assembly of claim 1 wherein:
the shaped reflector has a central disc of high reflectivity with an annular region surrounding the central disc and having a relatively lower reflectivity.

13. The diffusing assembly of claim 1 wherein:
the shaped reflector has a star-like shape having a reflectivity which is high near the center of the star and decreases along the length of each spoke.

14. An assembly for diffusing a plurality of LEDs having a central axis, the assembly comprising:
a diffusing device having a front surface facing an intended observer, a rear surface opposing the front surface, and perimeter edge surfaces,
where the rear surface of the diffusing device faces the LEDs; and
a plurality of shaped reflectors placed on the rear surface of the diffusing device where each shaped reflector is substantially aligned with the central axis of an LED.

15. The diffusing assembly of claim 14 wherein:
each shaped reflector comprises any one of the following: paint, ink, metals, and dielectrics.

16. The diffusing assembly of claim 14 wherein:
each shaped reflector comprises a textured portion of the rear surface of the diffusing device.

17. The diffusing assembly of claim 14 wherein:
the reflectivity of each shaped reflector is highest near the axis of the LED and decreases as you move away from the axis and parallel to the rear surface of the diffusing device.

18. The diffusing assembly of claim 14 wherein:
each shaped reflector comprises reflective metallic particles embedded into the diffusing device.

19. An assembly for diffusing a plurality of LEDs mounted on a PCB and having a central axis, the assembly comprising:
a diffusing device having an incident light surface facing the LEDs;
a plurality of light-scattering particles dispersed throughout the diffusing device;
a plurality of shaped reflectors placed on the incident light surface of the diffusing device where the shaped reflectors are placed in a one-to-one relationship with the LEDs, each shaped reflector having a central portion generally aligned with the central axis of the LED and an edge portion surrounding the central portion, and where the reflectivity at the central portion is higher than the reflectivity at the edge portion.

20. The diffusing assembly of claim 19 wherein:
the central portion of each shaped reflector reflects between 98% and 60% of the optical energy of on-axis light rays from the LED.
